(19) United States
(12) Patent Application Publication
(10) Pub. No.: US 2006/0210917 A1
(43) Pub. Date: Sep. 21, 2006

(54) Positive-working, thermally sensitive imageable element

(75) Inventors: Kevin Barry Ray, Fort Collins, CO (US); Eugene Sheriff, Carr, CO (US); Joanne Ray, Fort Collins, CO (US); James Mulligan, Fort Collins, CO (US); Eric Clark, Loveland, CO (US); Andrew Krebs, Greeley, CO (US)

Correspondence Address: PATENT LEGAL STAFF, EASTMAN KODAK COMPANY, 343 STATE STREET, ROCHESTER, NY, 14650-2201, US

(73) Assignee: Kodak Polychrome Graphics LLC

(21) Appl. No.: 11/084,445

(22) Filed: Mar. 18, 2005

(51) Int. Cl. G03C 1/76

(52) U.S. Cl. 430/270.1

(57) ABSTRACT

Imageable elements that contain copolymers soluble in alkaline solutions are disclosed and methods for forming imaging using the imageable elements are disclosed. The alkali soluble copolymers comprise about 3 to about 50 mol % of one or more of the monomers of the formula: CH₂═CH(R¹)—C(O)—X—Y—R²; in which: R¹ is H or CH₃; R² is succinimide or phthalimide; X is O or NH; and Y is —(CH₂)ₙ—, in which n is an integer from 2 to 12. The imageable elements are useful as lithographic printing plate precursors.

### FIELD OF THE INVENTION

The invention relates to lithographic printing. In particular, this invention relates to imageable elements useful as lithographic printing plate precursors that have good solvent resistance.

### BACKGROUND OF THE INVENTION

In conventional or “wet” lithographic printing, ink receptive regions, known as image areas, are generated on a hydrophilic surface. When the surface is moistened with water and ink is applied, the hydrophilic regions retain the water and repel the ink, and the ink receptive regions accept the ink and repel the water. The ink is transferred to the surface of a material upon which the image is to be reproduced. Typically, the ink is first transferred to an intermediate blanket, which in turn transfers the ink to the surface of the material upon which the image is to be reproduced.

Imageable elements useful as lithographic printing plate precursors typically comprise an imageable layer applied over the hydrophilic surface of a substrate. The imageable layer includes one or more radiation-sensitive components, which may be dispersed in a suitable binder. Alternatively, the radiation-sensitive component can also be the binder material. Following imaging, either the imaged regions or the unimaged regions of the imageable layer are removed by a suitable developer, revealing the underlying hydrophilic surface of the substrate. If the imaged regions are removed, the precursor is positive working. Conversely, if the unimaged regions are removed, the precursor is negative working. In each instance, the regions of the imageable layer (i.e., the image areas) that remain are ink-receptive, and the regions of the hydrophilic surface revealed by the developing process accept water and aqueous solutions, typically a fountain solution, and repel ink.

Direct digital imaging, which obviates the need for imaging through a mask, is becoming increasingly important in the printing industry. Imageable elements for the preparation of lithographic printing plates have been developed for use with infrared lasers. Thermally imageable, multi-layer elements are disclosed, for example, in Shimazu, U.S. Pat. No. 6,294,311, U.S. Pat. No. 6,352,812, and U.S. Pat. No. 6,593,055; Patel, U.S. Pat. No. 6,352,811; Savariar-Hauck, U.S. Pat. No. 6,358,669, and U.S. Pat. No. 6,528,228; and Kitson, U.S. Pat. No. 6,858,359, the disclosures of which are all incorporated herein by reference.

In use, a lithographic printing plate comes in contact with fountain solution. In addition, the printing plate is often subjected to aggressive blanket washes, such as a “UV wash” to remove ultraviolet curable inks. Thus, a need exists for positive working, multi-layer, thermally imageable elements, useful as lithographic printing plate precursors, that have resistance to these solvents.

### SUMMARY OF THE INVENTION

In one aspect, the invention is an imageable element that has excellent chemical resistance. The imageable element comprises an imageable layer over a substrate, the imageable element comprises a photothermal conversion material and a copolymer comprising in polymerized form:

(a) about 5 mol % to about 40 mol % of acrylic acid, methacrylic acid, vinyl benzoic acid, or a mixture thereof;

(b) about 20 mol % to about 75 mol % of N-phenylmaleimide, N-cyclohexylmaleimide, N-benzylmaleimide, or a mixture thereof;

(c) about 5 mol % to about 50 mol % of acrylamide, methacrylamide, N-methoxymethylacrylamide, N-methoxymethylmethacrylamide, methoxymethyl methacrylate, or a mixture thereof; and

(d) about 3 to about 50 mol % of one or more of the monomers of the formula: CH₂═CH(R¹)—C(O)—X—Y—R²;

in which:

R¹ is H or CH₃;

R² is succinimide or phthalimide;

X is O or NH;

Y is —(CH₂)ₙ—, in which n is an integer from 2 to 12; and

the copolymer is soluble in alkaline solutions.

In another aspect, the invention is a method for forming an image by imaging and developing the imageable element. In yet another aspect, the invention is an image formed by the method of imaging and developing the imageable element.

### DETAILED DESCRIPTION OF THE INVENTION

Unless the context indicates otherwise, in the specification and claims, the terms alkali soluble copolymer, novolac resin, binder, additional monomer, photothermal conversion material, surfactant, and similar terms also include mixtures of such materials. Unless otherwise specified, all percentages are percentages by weight and all temperatures are in degrees Centigrade (degrees Celsius). Thermal imaging refers to imaging with a hot body, such as a thermal head, or with infrared radiation.

### Alkali Soluble Copolymers

Although the copolymers have been defined in terms of the monomers that conceptually can be used to form the copolymers, this does not limit the copolymers to those formed by polymerization of the indicated monomers. The copolymers may be formed by other routes, such as by modification of precursor polymers. For example, the copolymer may be formed by formation of succinimide and/or phthalimide groups on a precursor polymer that has free amino groups. The alkali soluble copolymers are soluble in alkaline solutions, typically in solutions having a pH of about 8 or greater, such as alkaline solutions having a pH of about 8 to about 13.5.

The alkali soluble copolymers comprise, in polymerized form, about 5 mol % to about 40 mol %, preferably about 10 mol % to about 30 mol % of acrylic acid, methacrylic acid, vinyl benzoic acid, or a mixture thereof. Methacrylic acid is preferred.

The alkali soluble copolymers comprise, in polymerized form, about 20 mol % to about 75 mol %, preferably about 20 mol % to about 50 mol %, of N-phenylmaleimide, N-cyclohexylmaleimide, N-benzylmaleimide, or a mixture thereof. N-Phenylmaleimide is preferred.

The alkali soluble copolymers comprise, in polymerized form, about 5 mol % to about 50 mol %, preferably about 15 mol % to about 40 mol %, of acrylamide, methacrylamide, N-methoxymethylacrylamide, N-methoxymethylmethacrylamide, methoxymethyl methacrylate, or a mixture thereof. Methacrylamide is preferred.

The alkali soluble copolymers comprise, in polymerized form, about 3 mol % to about 50 mol %, preferably about 10 mol % to about 40 mol %, of one or more monomers of the formula: CH₂═CH(R¹)—C(O)—X—Y—R². R¹ is H or CH₃, preferably CH₃. R² is succinimide or phthalimide. X is O or NH, preferably O. Y is —(CH₂)ₙ—, in which n is an integer from 2 to 12, preferably 2.

The succinimide group has the structure:

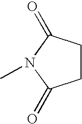

The phthalimide group has the structure:

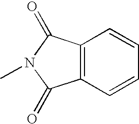

Preferred monomers include N-(methacryloxyethyl)succinimide, N-methacryloxyethyl)phthalimide, and mixtures thereof.

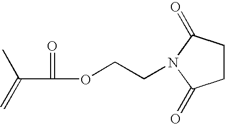

### N-(Methacryloxyethyl)succinimide (MAOES)

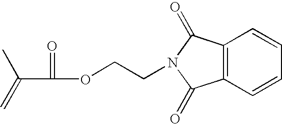

### N-(Methacryloxyethyl)phthalimide (MAOEP)

Additional monomers may be present in the alkali soluble copolymer. The alkali soluble copolymer may additionally comprise, in polymerized form, about 10 mol % to about 70 mol %, preferably 20 mol % to 60 mol %, of acrylonitrile, methacrylonitrile, or a mixture thereof and/or about 10 mol % to about 40 mol % of maleic anhydride.

The alkali soluble copolymers may be prepared by various routes. The copolymers may be prepared by, for example, free radical polymerization. For example, the monomers indicated above may be polymerized in the desired amounts to produce the desired alkali soluble copolymer.

Free radical polymerization is well known to those skilled in the art and is described, for example, in Chapters 20 and 21, of Macromolecules, Vol. 2, 2nd Ed., H. G. Elias, Plenum, N.Y., 1984. Useful free radical initiators are peroxides such as benzoyl peroxide, hydroperoxides such as cumyl hydroperoxide and azo compounds such as 2,2′-azobis(isobutyronitrile) (AIBN). Chain transfer agents, such as dodecyl mercaptan, may be used to control the molecular weight of the compound. Suitable solvents for free radical polymerization include liquids that are inert to the reactants and which will not otherwise adversely affect the reaction, for example, water, esters such as ethyl acetate and butyl acetate; ketones such as methyl ethyl ketone, methyl isobutyl ketone, methyl propyl ketone, and acetone; alcohols such as methanol, ethanol, isopropyl alcohol, and butanol; ethers such as dioxane, dioxolane, and tetrahydrofuran, and mixtures thereof.

Monomers may be polymerized in the desired amounts to produce the desired alkali soluble copolymer. For example, the desired amounts of the monomers of (a), (b), (c), (d), and, if present, the additional monomer or monomers, may be copolymerized to produced the desired polymer. The copolymers may be formed by other routes that will be apparent to those skilled in the art, such as by modification of precursor polymers. For example, the copolymer may be formed by formation of succinimide and/or phthalimide groups on an appropriate precursor polymer that has free amino groups.

### Imageable Elements

The alkali soluble copolymers may be used in positive working imageable elements. The imageable element comprises an imageable layer or top layer, which comprises an imageable composition, over the surface of a substrate. Other layers that are conventional components of imageable elements may also be present. For example, the imageable layer may be on the substrate, or other layers, such as an underlayer, may be present between the imageable layer and the substrate. The imageable element also comprises a photothermal conversion material, which may be present in the imageable layer, in an underlayer, and/or in a separate absorber layer between the imageable layer and the underlayer if the underlayer is present, and/or between the imageable layer and the substrate if the underlayer is not present.

### Substrate

The substrate comprises a support, which may be any material conventionally used to prepare imageable elements useful as lithographic printing plates. The support is preferably strong, stable, and flexible. It should resist dimensional change under conditions of use so that color records will register in a full-color image. Typically, it can be any self-supporting material, including, for example, polymeric films such as polyethylene terephthalate film, ceramics, metals, or stiff papers, or a lamination of any of these materials. Metal supports include aluminum, zinc, titanium, and alloys thereof.

Typically, polymeric films contain a sub-coating on one or both surfaces improve adhesion to subsequent layers. The nature of this layer or layers depends upon the substrate and the composition of subsequent layer or layers. Examples of subbing layer materials are adhesion-promoting materials, such as alkoxysilanes, aminopropyltriethoxysilane, glycidoxypropyltriethoxysilane and epoxy functional polymers, as well as conventional subbing materials used on polyester bases in photographic films.

When the substrate comprises a sheet of aluminum or an aluminum alloy, it should be of sufficient thickness to sustain the wear from printing and thin enough to wrap around a cylinder in a printing press, typically about 100 μm to about 600 μm. It is typically cleaned, roughened, and anodized by various methods known in the art. Initially, a degreasing treatment with a surfactant, an organic solvent, or an alkaline water solution is typically administered to the remove oil and grease from the surface of the sheet. Then the surface may be roughened by well known techniques, such as mechanical roughening, for example ball polishing, brush polishing, blast polishing and buff polishing, chemical roughening in which the surface is roughened by selectively dissolving the surface, or electrochemical roughening, or a combination of such chemical, mechanical, and/or electrochemical treatments (multi-graining). Etching of the substrate is performed using hot acidic (such as sulfuric or phosphoric) solutions or alkaline solutions (such as sodium hydroxide or trisodium phosphate mixed with sodium hydroxide). Anodic oxidation may be carried out to form a hydrophilic layer of aluminum oxide of the surface, typically a layer of aluminum oxide of at least 0.3 g/m² in weight. Anodic oxidation is performed by passing a current using the support as an anode in an electrolytic solution comprising an electrolyte, such as, for example, sulfuric acid, phosphoric acid, chromic acid, boric acid, citric acid, oxalic acid, or a mixture thereof. Anodic oxidation is disclosed, for example, in Fromson, U.S. Pat. No. 3,280,734, and Chu, U.S. Pat. No. 5,152,158.

Then, the cleaned, roughened, and anodized support may be hydrophilized with an alkali metal silicate, such as aqueous potassium silicate, lithium silicate, or, typically, sodium silicate. Hydrophilization is described, for example, in Jewett, U.S. Pat. No. 2,714,066, and Fromson, U.S. Pat. No. 3,181,461. The support is either immersed in or electrolyzed in an aqueous solution of the alkali metal silicate.

Typically, the substrate comprises an interlayer between the aluminum support and the overlying layer or layers. The interlayer may be formed by treatment of the aluminum support with, for example, silicate, dextrine, hexafluorosilicic acid, phosphate/fluoride, polyvinyl phosphonic acid (PVPA), vinyl phosphonic acid co-polymers, or a water-soluble diazo resin. Co-polymers that comprise (1) phosphonic acid groups and/or phosphate groups, and (2) acid groups and/or groups that comprise alkylene glycol or polyalkylene glycol side chains, which are useful as interlayer materials, are also disclosed in U.S. patent application Ser. No. 10/922,782, filed Aug. 20, 2004, the disclosure of which are incorporated herein by reference. Co-polymers that comprise (1) acid groups and/or phosphonic acid groups, and (2) silyl groups substituted with three alkoxy and/or phenoxy groups, useful as interlayer material, are disclosed in U.S. patent application Ser. No. 10/928,339, filed Aug. 27, 2004, the disclosure of which are incorporated herein by reference.

The back side of the support (i.e., the side opposite the imageable layer) may be coated with an antistatic agent and/or a slipping layer or matte layer to improve handling and “feel” of the imageable element.

### Photothermal Conversion Material

Imageable elements that are to be imaged with infrared radiation typically comprise an infrared absorber, known as a photothermal conversion material. Photothermal conversion materials absorb radiation and convert it to heat. Although a photothermal conversion material is not necessary for imaging with a hot body, imageable elements that contain a photothermal conversion material may also be imaged with a hot body, such as a thermal head or an array of thermal heads.

The photothermal conversion material may be any material that can absorb radiation and convert it to heat. Suitable materials include dyes and pigments. Suitable pigments include, for example, carbon black, Heliogen Green, Nigrosine Base, iron (III) oxide, manganese oxide, Prussian Blue, and Paris Blue. Because of its low cost and wide absorption bands that allow it to be used with imaging devices having a wide range of peak emission wavelengths, one particularly useful pigment is carbon black. The size of the pigment particles should not be more than the thickness of the layer that contains the pigment. Preferably, the size of the particles will be half the thickness of the layer or less.

To prevent sludging of the developer by insoluble material, photothermal conversion materials that are soluble in the developer are preferred. The photothermal conversion material may be a dye with the appropriate absorption spectrum and solubility. Dyes, especially dyes with a high extinction coefficient in the range of 750 nm to 1200 nm, are preferred. Examples of suitable dyes include dyes of the following classes: methine, polymethine, arylmethine, cyanine, hemicyanine, streptocyanine, squarylium, pyrylium, oxonol, naphthoquinone, anthraquinone, porphyrin, azo, croconium, triarylamine, thiazolium, indolium, oxazolium, indocyanine, indotricarbocyanine, oxatricarbocyanine, phthalocyanine, thiocyanine, thiatricarbocyanine, merocyanine, cryptocyanine, naphthalocyanine, polyaniline, polypyrrole, polythiophene, chalcogenopyryloarylidene and bis(chalcogenopyrylo)polymethine, oxyindolizine, pyrazoline azo, and oxazine classes. Absorbing dyes are disclosed in numerous publications, for example, Nagasaka, EP 0,823,327; DeBoer, U.S. Pat. No. 4,973,572; Jandrue, U.S. Pat. No. 5,244,771; Patel, U.S. Pat. No. 5,208,135; and Chapman, U.S. Pat. No. 5,401,618. Other examples of useful absorbing dyes include: ADS-830A and ADS-1064 (American Dye Source, Montreal, Canada), EC2117 (FEW, Wolfen, Germany), Cyasorb IR 99 and Cyasorb IR 165 (Glendale Protective Technology), Epolite IV-62B and Epolite III-178 (Epoline), SpectralR 830A and SpectralR 840A (Spectra Colors), as well as IR Dye A, and IR Dye B, whose structures are shown below.

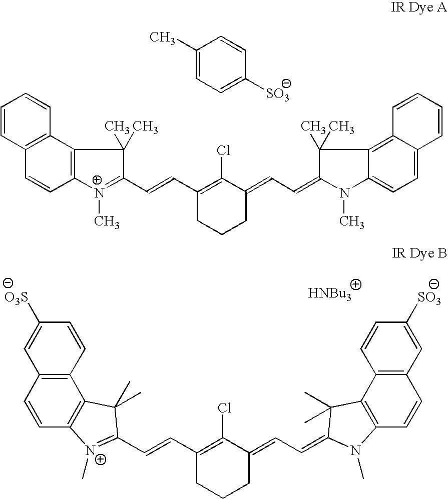

The amount of photothermal conversion present in the element is generally sufficient to provide an optical density of at least 0.05, and preferably, an optical density of from about 0.5 to at least about 2 to 3 at the imaging wavelength. As is well known to those skilled in the art, the amount of compound required to produce a particular optical density at a particular wavelength can be determined using Beer's law.

To prevent ablation during imaging with infrared radiation, when the element is a multi-layer imageable element, the imageable layer is preferably substantially free of photothermal conversion material. That is, the photothermal conversion material in the imageable layer, if any, absorbs less than about 10% of the imaging radiation, preferably less than about 3% of the imaging radiation, and the amount of imaging radiation absorbed by the imageable layer, if any, is not enough to cause ablation of the imageable layer.

### Single Layer Elements

Single layer elements comprise a layer of an imageable composition, known as the top layer or imageable layer, over, typically on, the substrate. The imageable layer becomes soluble or dispersible in the developer following thermal exposure. Thermally imageable, single layer elements are disclosed, for example, in West, U.S. Pat. No. 6,090,532; Parsons, U.S. Pat. No. 6,280,899; McCullough, U.S. Pat. Pub. No. 2002/0136961; and WO99/21715. The imageable composition typically comprises an ink-receptive novolac resin, which may act as a binder, a dissolution inhibitor, a photothermal conversion material, and the alkali soluble copolymer above or a mixture of the alkali soluble copolymers. Alternatively, or additionally, the novolac resin may comprise polar groups and acts both as a binder and dissolution inhibitor. Other materials that are conventional components of the imageable layer of single layer imageable elements may also be present.

Novolac resins are commercially available and are well known to those skilled in the art. They are typically prepared by the condensation reaction of a phenol, such as phenol, m-cresol, o-cresol, p-cresol, etc, with an aldehyde, such as formaldehyde, paraformaldehyde, acetaldehyde, etc. or a ketone, such as acetone, in the presence of an acid catalyst. Typical novolac resins include, for example, phenol-formaldehyde resins, cresol-formaldehyde resins, phenol-cresol-formaldehyde resins, p-t-butylphenol-formaldehyde resins, and pyrogallol-acetone resins. Particularly useful novolac resins are prepared by reacting m-cresol, mixtures of m-cresol and p-cresol, or phenol with formaldehyde using conventional conditions.

The imageable layer preferably comprises a dissolution inhibitor, which functions as a solubility-suppressing component for the novolac resin. Dissolution inhibitors have polar functional groups that are believed to act as acceptor sites for hydrogen bonding with the hydroxyl groups present in the binder. The acceptor sites comprise atoms with high electron density, preferably selected from electronegative first row elements, especially carbon, nitrogen, and oxygen. Dissolution inhibitors that are soluble in the developer are preferred.

Useful polar groups for dissolution inhibitors include, for example, diazo groups; diazonium groups; keto groups; sulfonic acid ester groups; phosphate ester groups; triarylmethane groups; onium groups, such as sulfonium, iodonium, and phosphonium; groups in which a nitrogen atom is incorporated into a heterocyclic ring; and groups that contain a positively charged atom, especially a positively charged nitrogen atom, typically a quaternized nitrogen atom, i.e., ammonium groups. Compounds that contain a positively charged (i.e., quaternized) nitrogen atom useful as dissolution inhibitors include, for example, tetraalkyl ammonium compounds, and quaternized heterocyclic compounds such as quinolinium compounds, benzothiazolium compounds, pyridinium compounds, and imidazolium compounds. Compounds containing other polar groups, such as ether, amine, azo, nitro, ferrocenium, sulfoxide, sulfone, and disulfone may also be useful as dissolution inhibitors. The dissolution inhibitor may be a monomeric and/or polymeric compound that comprises an o-diazonaphthoquinone moiety.

A preferred group of dissolution inhibitors are triarylmethane dyes, such as ethyl violet, crystal violet, malachite green, brilliant green, Victoria blue B, Victoria blue R, Victoria blue BO, BASONYL® Violet 610, and D11 (PCAS, Longjumeau, France). These compounds can also act as contrast dyes, which distinguish the unimaged regions from the imaged regions in the developed imageable element.

Alternatively, or additionally, the polymeric material in the imageable layer can comprise polar groups that act as acceptor sites for hydrogen bonding with the hydroxy groups present in the novolac resin, and, thus, act as both a binder and dissolution inhibitor. The level of derivatization should be high enough that the polymeric material acts as a dissolution inhibitor, but not so high that, following thermal imaging, the polymeric material is not soluble in the developer. Although the degree of derivatization required will depend on the nature of the polymeric material and the nature of the moiety containing the polar groups introduced into the polymeric material, typically about 0.5 mol % to about 5 mol %, preferably about 1 mol % to about 3 mol %, of the hydroxyl groups will be derivatized. Derivatization of phenolic resins with compounds that contain the diazonaphthoquinone moiety is well known and is described, for example, in West, U.S. Pat. Nos. 5,705,308, and 5,705,322.

One group of binders that comprise polar groups and function as dissolution inhibitors are derivatized phenolic polymeric materials in which a portion of the phenolic hydroxyl groups have been converted to sulfonic acid esters, preferably phenyl sulfonates or p-toluene sulfonates. Derivatization can be carried out by reaction of the polymeric material with, for example, a sulfonyl chloride such as p-toluene sulfonyl chloride in the presence of a base such as a tertiary amine. A useful material is a novolac resin in which about 1 mol % to 3 mol %, preferably about 1.5 mol % to about 2.5 mol %, of the hydroxyl groups have been converted to phenyl sulfonate or p-toluene sulfonate (tosyl) groups.

The imageable composition and imageable layer of the single layer imageable element may also comprise other ingredients such as dyes and surfactants that are conventional ingredients of imageable compositions. Surfactants may be present as, for example, coating aids. A dye may be present to aid in the visual inspection of the imaged and/or developed element. Printout dyes distinguish the imaged regions from the unimaged regions during processing. Contrast dyes distinguish the unimaged regions from the imaged regions in the developed imageable element. Preferably the dye does not absorb the imaging radiation. Triarylmethane dyes, such as described above, may also act as contrast dyes.

In single layer imageable elements, the imageable layer typically comprises, based on the dry weight of the imageable layer, about 40 wt % to about 80 wt %, preferably about 50 wt % to 70 wt %, of the novolac resin or mixture of novolac resins, about 0.5 wt % to about 30 wt %, preferably about 1 wt % to 15 wt %, of the dissolution inhibitor or mixture of dissolution inhibitors, 0.5 wt % to about 20 wt %, preferably about 1 wt % to 10 wt %, of the photothermal conversion material, and about 5 wt % to about 25 wt %, preferably about 10 wt % to 20 wt %, of the alkali soluble copolymer or mixture of alkali soluble copolymers.

### Multilayer Elements

Multilayer elements comprise a top layer or imageable layer over an underlayer. Other layers, such as an absorber layer and/or a barrier layer may also be present. When an underlayer is present, the alkali soluble copolymer or mixture of alkali soluble copolymers is in the underlayer.

Any imageable layer conventionally used in multi-layer, positive working, alkaline developable, thermally imageable elements may be used in the multilayer imageable elements. These elements are disclosed, for example, in Shimazu, U.S. Pat. No. 6,294,311, U.S. Pat. No. 6,352,812, and U.S. Pat. No. 6,593,055; Patel, U.S. Pat. No. 6,352,811; Hauck, U.S. Pat. No. 6,358,669; Savariar-Hauck, U.S. Pat. No. 6,528,228; and Kitson, U.S. Pat. No. 6,858,359, the disclosures of which are incorporated herein by reference.

The imageable layer of a multilayer imageable element is over the underlayer. The imageable layer becomes soluble or dispersible in the developer following thermal exposure. It typically comprises an ink-receptive polymeric material, known as the binder, and a dissolution inhibitor. Alternatively, or additionally, the polymeric material comprises polar groups and acts as both the binder and dissolution inhibitor. Other materials that are conventional components of the imageable layer of multilayer imageable elements may also be present. The imageable layer of a multilayer element is typically similar to the imageable layer of the single layer imageable elements described above, with the exception that the alkali soluble copolymer or mixture of alkali soluble copolymers, is typically not present.

Binders for the imageable layer of multilayer imageable elements are light-stable, water-insoluble, developer-soluble, film-forming novolac resins, such as are described above. In some cases, it may be desirable to include a novolac resin in the imageable layer with the highest weight average molecular weight that maintains its solubility in common coating solvents, such as acetone, tetrahydrofuran, and 1-methoxypropan-2-ol. Imageable layers comprising novolac resins, including for example m-cresol only novolac resins (i.e. those that contain at least about 97 mol % m-cresol) and m-cresol/p-cresol novolac resins that have up to 10 mol % of p-cresol, having a weight average molecular weight of about 10,000 to at least about 25,000, may be used. Imageable layers comprising m-cresol/p-cresol novolac resins with at least 10 mol % p-cresol, having a weight average molecular weight of about 8,000 to about 25,000, may also be used. In some instances, novolac resins prepared by solvent condensation may be desirable. Imageable layers comprising these resins are disclosed in Kitson. U.S. Pat. No. 6,858,359.

Dissolution inhibitors for the imageable layer of multilayer imageable elements are described above. The imageable layer also comprises other ingredients that are conventional ingredients of the imageable layer of multilayer imageable elements. These include, for example, surfactants and dyes, such as are described above.

The underlayer is between the hydrophilic surface of the substrate and the imageable layer. After imaging, it is removed along with the imageable layer by the developer in the imaged regions to reveal the underlying hydrophilic surface of the substrate. The underlayer comprises the alkali soluble copolymer. Other ingredients that are conventional ingredients of the underlayer of multilayer thermally imageable elements, such as surfactants, may also be present.

The underlayer may additionally comprise a binder, which is preferably soluble in the developer to prevent sludging of the developer. In addition, it is preferably insoluble in the solvent used to coat the imageable layer so that the imageable layer can be coated over the underlayer without dissolving the underlayer.

Polymeric materials useful as the binder in the underlayer include those that contain an acid and/or phenolic functionality, and mixtures of such materials. Particularly useful polymeric materials are copolymers that comprise N-substituted maleimides, especially N-phenylmaleimide; polyvinylacetals; methacrylamides, especially methacrylamide; and acrylic and/or methacrylic acid, especially methacrylic acid. More preferably, two functional groups are present in the polymeric material, and most preferably, all three functional groups are present in the polymeric material. The preferred polymeric materials of this type are copolymers of N-phenylmaleimide, methacrylamide, and methacrylic acid, more preferably those that contain, in polymerized form, about 25 to about 75 mol %, preferably about 35 to about 60 mol % of N-phenylmaleimide; about 10 to about 50 mol %, preferably about 15 to about 40 mol % of methacrylamide; and about 5 to about 30 mol %, preferably about 10 to about 30 mol %, of methacrylic acid. Other hydrophilic monomers, such as hydroxyethyl methacrylate, may be used in place of some or all of the methacrylamide. Other alkaline soluble monomers, such as acrylic acid, may be used in place of some or all of the methacrylic acid.

These polymeric materials are soluble in alkaline developers. In addition, they are soluble in a methyl lactate/methanol/dioxolane (15:42.5:42.5 wt %) mixture, which can be used as the coating solvent for the underlayer. However, they are poorly soluble in solvents such as acetone, which can be used as solvents to coat the imageable layer on top of the underlayer without dissolving the underlayer.

The underlayer may also comprise a resin or resins having activated methylol and/or activated alkylated methylol groups. Such resins include, for example: resole resins and their alkylated analogs; methylol melamine resins and their alkylated analogs, for example melamine-formaldehyde resins; methylol glycoluril resins and alkylated analogs, for example, glycoluril-formaldehyde resins; thiourea-formaldehyde resins; guanamine-formaldehyde resins; and benzoguanamine-formaldehyde resins. Commercially available melamine-formaldehyde resins and glycoluril-formaldehyde resins include, for example, CYMEL® resins (Dyno Cyanamid) and NIKALAC® resins (Sanwa Chemical).

The resin or resins having activated methylol and/or activated alkylated methylol groups is preferably a resole resin or a mixture of resole resins. Resole resins are well known to those skilled in the art. They are prepared by reaction of a phenol with an aldehyde under basic conditions using an excess of phenol. Commercially available resole resins include, for example, GP649D99 resole (Georgia Pacific) and BKS-5928 resole resin (Union Carbide).

When the binder and resin having activated alkylated methylol groups are present, the underlayer typically comprises about 50 wt % to about 75 wt %, preferably about 55 wt % to 70 wt %, of the binder or mixture of binders, based on the dry weight of the underlayer; about 5 wt % to about 20 wt %, preferably about 7 wt % to 15 wt %, of the resin or mixture of resins having activated methylol and/or activated alkylated methylol groups, based on the dry weight of the underlayer; about 5 wt % to about 25 wt %, preferably about 10 wt % to 20 wt %, of the photothermal conversion material, based on the dry weight of the underlayer; and about 3 wt % to about 30 wt %, preferably about 5 wt % to 20 wt %, of the alkali soluble copolymer or mixture of alkali soluble copolymers, based on the dry weight of the underlayer.

The underlayer of a multilayer imageable element typically comprises the photothermal conversion material. Alternatively, the photothermal material may be in the imageable layer or in a separate absorber layer.

When an absorber layer is present, it is between the imageable layer and the substrate. When an underlayer is also present, the absorber layer is between the imageable layer and the underlayer. The absorber layer preferably consists essentially of the infrared absorbing compound and, optionally, a surfactant. It may be possible to use less of the infrared absorbing compound if it is present in a separate absorber layer rather than either the underlayer and/or the imageable layer. When an absorber layer is present, the imageable layer is preferably substantially free of infrared absorbing compound, i.e. the imageable layer preferably does not absorb radiation used for imaging, typically radiation in the range of 800 nm to 1200 nm. The absorber layer preferably has a thickness sufficient to absorb at least 90%, preferably at least 99%, of the imaging radiation. Typically, the absorber layer has a coating weight of about 0.02 g/m² to about 2 g/m², preferably about 0.05 g/m² to about 1.5 g/m². Elements that comprise an absorber layer are disclosed in Shimazu, U.S. Pat. No. 6,593,055.

To minimize migration of the photothermal conversion material from the underlayer to the imageable layer during manufacture and storage of the imageable element, the element may comprise a barrier layer between the underlayer and the imageable layer. The barrier layer comprises a polymeric material that is soluble in the developer. If this polymeric material is different from the polymeric material in the underlayer, it is preferably soluble in at least one organic solvent in which the polymeric material in the underlayer is insoluble. A preferred polymeric material for the barrier layer is polyvinyl alcohol. When the polymeric material in the barrier layer is different from the polymeric material in the underlayer, the barrier layer should be less than about one-fifth as thick as the underlayer, preferably less than a tenth of the thickness of the underlayer.

### Preparation of the Imageable Element

Single layer imageable elements may be prepared by applying the imageable layer to the substrate using conventional techniques, such as coating or lamination. Typically, the ingredients are dissolved in an appropriate coating solvent, and the resulting mixture coated onto the hydrophilic surface of substrate by conventional methods, such as spin coating, bar coating, gravure coating, die coating, or roller coating.

Multi-layer imageable elements may be prepared by sequentially applying the underlayer over the hydrophilic surface of the substrate; applying the absorber layer or the barrier layer if present, over the underlayer; and then applying the imageable layer using conventional techniques. Typically the ingredients are dispersed or dissolved in a suitable coating solvent, and the resulting mixture coated by conventional methods, such as spin coating, bar coating, gravure coating, die coating, or roller coating. The underlayer may be applied, for example, from mixtures of methyl ethyl ketone, 1-methoxypropan-2-ol, butyrolactone, and water; from mixtures of diethyl ketone, water, methyl lactate, and butyrolactone; and from mixtures of diethyl ketone, water, and methyl lactate.

When neither a barrier layer nor an absorber layer is present, the imageable layer is coated on the underlayer. To prevent the underlayer from dissolving and mixing with the imageable layer, the imageable layer should be coated from a solvent in which the underlayer layer is essentially insoluble. Thus, the coating solvent for the imageable layer should be a solvent in which the components of the imageable layer are sufficiently soluble that the imageable layer can be formed and in which any underlying layers are essentially insoluble. Typically, the solvents used to coat the underlying layers are more polar than the solvent used to coat the imageable layer. The imageable layer may be applied, for example, from diethyl ketone, or from mixtures of diethyl ketone and 1-methoxy-2-propyl acetate. An intermediate drying step, i.e., drying the underlayer, if present, to remove coating solvent before coating the imageable layer over it, may also be used to prevent mixing of the layers.

Alternatively, the underlayer, the imageable layer or both layers may be applied by conventional extrusion coating methods from a melt mixture of layer components. Typically, such a melt mixture contains no volatile organic solvents.

### Imaging and Processing

The element may be thermally imaged with a laser or an array of lasers emitting modulated near infrared or infrared radiation in a wavelength region that is absorbed by the imageable element. Infrared radiation, especially infrared radiation in the range of about 800 nm to about 1200 nm, is typically used for imaging. Imaging is conveniently carried out with a laser emitting at about 830 nm, about 1056 nm, or about 1064 nm. Suitable commercially available imaging devices include image setters such as the CREO® Trendsetter (Creo, Burnaby, British Columbia, Canada), the Screen PlateRite model 4300, model 8600, and model 8800 (Screen, Rolling Meadows, Chicago, Ill., USA), and the Gerber Crescent 42T (Gerber).

Alternatively, the imageable element may be thermally imaged using a hot body, such as a conventional apparatus containing a thermal printing head. A suitable apparatus includes at least one thermal head but would usually include a thermal head array, such as a TDK Model No. LV5416 used in thermal fax machines and sublimation printers, the GS618-400 thermal plotter (Oyo Instruments, Houston, Tex., USA), or the Model VP-3500 thermal printer (Seikosha America, Mahwah, N.J., USA).

Imaging produces an imaged element, which comprises a latent image of imaged regions and complementary unimaged regions. Development of the imaged element to form a printing plate, or printing form, converts the latent image to an image by removing the imaged regions, revealing the hydrophilic surface of the underlying substrate.

Suitable developers depend on the solubility characteristics of the ingredients present in the imageable element. The developer may be any liquid or solution that can penetrate and remove the imaged regions of the imageable element without substantially affecting the complementary unimaged regions. While not being bound by any theory or explanation, it is believed that image discrimination is based on a kinetic effect. The imaged regions of the imageable layer are removed more rapidly in the developer than the unimaged regions. Development is carried out for a long enough time to remove the imaged regions of the imageable layer and the underlying regions of the other layer or layers of the element, but not long enough to remove the unimaged regions of the imageable layer. Hence, the imageable layer is described as being “not removable” by, or “insoluble” in, the developer prior to imaging, and the imaged regions are described as being “soluble” in, or “removable” by, the developer because they are removed, i.e. dissolved and/or dispersed, more rapidly in the developer than the unimaged regions. Typically, the underlayer is dissolved in the developer and the imageable layer is dissolved and/or dispersed in the developer.

Useful developers are aqueous solutions having a pH of about 7 or above and solvent based alkaline developers. Common components of developers are surfactants; chelating agents, such as salts of ethylenediamine tetraacetic acid; organic solvents such as benzyl alcohol and phenoxyethanol; and alkaline components such as inorganic metasilicates, organic metasilicates, hydroxides or bicarbonates. Typical aqueous alkaline developers are those that have a pH between about 8 and about 13.5, typically at least about 11, preferably at least about 12.

The developer may also comprise a surfactant or a mixture of surfactants. Preferred surfactants include: alkali metal salts of alkyl naphthalene sulfonates; alkali metal salts of the sulfate monoesters of aliphatic alcohols, typically having six to nine carbon atoms; and alkali metal sulfonates, typically having six to nine carbon atoms. A preferred alkali metal is sodium. The surfactant or mixture of surfactants typically comprises about 0.5 wt % to about 15 wt % based on the weight of the developer, preferably about 3 wt % to about 8 wt %, based on the weight of the developer. As is well known to those skilled in the art, many surfactants are supplied as aqueous surfactant solutions. These percentages are based on the amount of surfactant (i.e. the amount of active ingredient or ingredients exclusive of water and other inactive materials in the surfactant solution) in the developer.

A developer may also comprise a buffer system to keep the pH relatively constant, typically between about 5.0 and about 12.0, preferably between about 6.0 and about 11.0, more preferably between about 8.0 and about 10.0. Numerous buffer systems are known to those skilled in the art. Typically buffer systems include, for example: combinations of water-soluble amines, such as mono-ethanol amine, diethanol amine, tri-ethanol amine, or tri-1-propyl amine, with a sulfonic acid, such as benzene sulfonic acid or 4-toluene sulfonic acid; mixtures of the tetra sodium salt of ethylene diamine tetracetic acid (EDTA) and EDTA; mixtures of phosphate salts, such as mixtures of mono-alkali phosphate salts with tri-alkali phosphate salts; and mixtures of alkali borates and boric acid. Water typically comprises the balance of the developer.

Solvent-based alkaline developers, which are typically used with negative working imageable elements, are excellent developers for use with the positive working, multi-layer, thermally imageable elements of this invention. Solvent-based developers comprise an organic solvent or a mixture of organic solvents. The developer is a single phase. Consequently, the organic solvent must be miscible with water, or at least soluble in the developer to the extent it is added to the developer, so that phase separation does not occur. The following solvents and mixtures of these solvents are suitable for use in the developer: the reaction products of phenol with ethylene oxide and propylene oxide, such as ethylene glycol phenyl ether (phenoxyethanol); benzyl alcohol; esters of ethylene glycol and of propylene glycol with acids having six or fewer carbon atoms, and ethers of ethylene glycol, diethylene glycol, and of propylene glycol with alkyl groups having six or fewer carbon atoms, such as 2-ethylethanol and 2-butoxyethanol. A single organic solvent or a mixture of organic solvents can be used. The organic solvent is typically present in the developer at a concentration of between about 0.5 wt % to about 15 wt %, based on the weight of the developer, preferably between about 3 wt % and about 5 wt %, based on the weight of the developer.

Useful commercially available solvent-based developers include ND-1 Developer, 956 Developer and 955 Developer (Kodak Polychrome Graphics, Norwalk, Conn., USA.). Developers consisting of 1 part ND-1 Developer and 3 to 5 parts of water are also useful. Another useful solvent-based developer is a mixture of 726.39 parts water, 6.64 parts monoethanolamine, 34.44 parts diethanolamine, 177.17 parts PELEX® NB-L (sodium alkyl naphthalene sulfonate anionic surfactant, Kao Corp., Chuo-ku, Tokyo, Japan), and 55.36 parts benzyl alcohol. Other useful developers are aqueous alkaline developers, such as 3000 Developer and 9000 Developer (Kodak Polychrome Graphics, Norwalk, Conn., USA).

The developer is typically applied to the precursor by spraying the element with sufficient force to remove the exposed regions. Alternatively, development may carried out in a processor equipped with an immersion-type developing bath, a section for rinsing with water, a gumming section, a drying section, and a conductivity-measuring unit, or the imaged precursor may be brushed with the developer. In each instance, a printing plate is produced. Development may conveniently be carried out in a commercially available spray-on processor, such as an 85 NS (Kodak Polychrome Graphics) or in a commercially available immersion-type processor such as the PK910 Mark II Processor (Kodak Polychrome Graphics).

High pH developers can be used. High pH developers typically have a pH of at least about 11, more typically at least about 12, even more typically from about 12 to about 14. High pH developers also typically comprise at least one alkali metal silicate, such as lithium silicate, sodium silicate, and/or potassium silicate, and are typically substantially free of organic solvents. The alkalinity can be provided by using a hydroxide or an alkali metal silicate, or a mixture. Preferred hydroxides are ammonium, sodium, lithium and, especially, potassium hydroxides. The alkali metal silicate has a SiO₂ to M₂O weight ratio of at least 0.3 (where M is the alkali metal), preferably this ratio is from 0.3 to 1.2, more preferably 0.6 to 1.1, most preferably 0.7 to 1.0. The amount of alkali metal silicate in the developer is at least 20 g SiO₂ per 100 g of composition and preferably from 20 to 80 g, most preferably it is from 40 to 65 g. High pH developers can be used in an immersion processor. Typical high pH developers include PC9000, PC3000, Goldstar™, Greenstar™, ThermalPro™, PROTHERM®, MX 1813, and MX1710, aqueous alkaline developers, all available from Kodak Polychrome Graphics LLC. Another useful developer contains 200 parts of Goldstar™ developer, 4 parts of polyethylene glycol (PEG) 1449, 1 part of sodium metasilicate pentahydrate, and 0.5 part of TRITON® H-22 surfactant (phosphate ester surfactant).

Following development, the resulting printing plate is rinsed with water and dried. Drying may be conveniently carried out by infrared radiators or with hot air. After drying, the printing plate may be treated with a gumming solution comprising one or more water-soluble polymers, for example polyvinylalcohol, polymethacrylic acid, polymethacrylamide, polyhydroxyethylmethacrylate, polyvinylmethylether, gelatin, and polysaccharide such as dextrine, pullulan, cellulose, gum arabic, and alginic acid. A preferred material is gum arabic.

The developed and gummed plate is baked to increase the press runlength of the plate. Baking can be carried out, for example, at about 220° C. to about 260° C. for about 5 minutes to about 15 minutes, or at a temperature of about 110° C. to about 130° C. for about 25 to about 35 min.

### INDUSTRIAL APPLICABILITY

Once a lithographic printing plate precursor has been imaged and developed to form a lithographic printing plate, printing can then be carried out by applying a fountain solution and then lithographic ink to the image on its surface. The fountain solution is taken up by the unimaged regions, i.e., the surface of the hydrophilic substrate revealed by the imaging and development process, and the ink is taken up by the imaged regions, i.e., the regions not removed by the development process. The ink is then transferred to a suitable receiving material (such as cloth, paper, metal, glass or plastic) either directly or indirectly using an offset printing blanket to provide a desired impression of the image thereon.

The advantageous properties of this invention can be observed by reference to the following examples, which illustrate but do not limit the invention.

### EXAMPLES

### Glossary

956 Developer Solvent based (phenoxyethanol) alkaline negative developer (Kodak Polychrome Graphics, Norwalk, Conn., USA)
AIBN 2,2′-Azobisisobutyronitrile (DuPont, Wilmington, Del., USA)
BASONYL® Violet 610 Crystal violet FN; Basic violet 3; Cl 42555; Triarylmethane dye; lambdaₘₐₓ=588 nm (Aldrich, Milwaukee, Wis., USA)
BC 2-Butoxyethanol (Butyl CELLOSOLVE®) (80 vol % in water)
BLO γ-Butyrolactone
BYK-307 Polyethoxylated dimethylpolysiloxane co-polymer (BYK Chemie, Wallingford, Conn., USA)
CAHPh Cellulose acetate hydrogen phthalate (Aldrich, Milwaukee, Wis. USA)
Copolymer 1 N-phenylmaleimide (30 mol %); methacrylamide (30 mol %); methacrylic acid (25 mol %); MAOEP (15 mol %)
Copolymer 2 N-phenylmaleimide (30 mol %), methacrylamide (30 mol %), methacrylic acid (25 mol %); MAOES (15 mol %)
Copolymer 3 N-phenylmaleimide (30 mol %), methacrylamide (25 mol %), methacrylic acid (30 mol %), MAOEP (15 mol %)
Copolymer 4 N-phenylmaleimide (30 mol %), methacrylamide (20 mol %), methacrylic acid (35 mol %), MAOEP (15 mol %)
Copolymer C1 N-phenylmaleimide (41.5 mol %), methacrylamide (37.5 mol %), methacrylic acid (21 mol %)
CREO® Trendsetter 3244x Commercially available platesetter, using Procom Plus software and having a laser diode array emitting at 830 nm (Creo Products, Burnaby, BC, Canada)
D11 Ethanaminium, N-[4-[[4-(diethylamino)phenyl][4-(ethylamino)-1-naphthalenyl]methylene]-2,5-cyclohexadien-1-ylidene]-N-ethyl-, salt with 5-benzoyl-4-hydroxy-2-methoxybenzenesulfonic acid (1:1); colorant dye (see structure below) (PCAS, Longjumeau, France); CAS # 433334-19-1
DAA Diacetone alcohol (80 vol % in water)
DUREZ® 33816 Novolac resin; 70% m-cresol/30% p-cresol; MW 45,000, manufactured by solvent condensation (Durez Corp., Grand Island, N.Y., USA)
Ethyl violet C.I. 42600; CAS 2390-59-2 (lambdaₘₐₓ=596 nm) [(p-(CH₃CH₂)₂NC₆H₄)₃C⁺Cl⁻] (Aldrich, Milwaukee, Wis., USA); CAS # 2390-59-2
Goldstar™ Plus Developer Sodium metasilicate based aqueous alkaline developer (Kodak Polychrome Graphics, Norwalk, Conn., USA)
IR Dye A Infrared absorbing dye (lambdaₘₐₓ=830 nm) (Eastman Kodak, Rochester, N.Y., USA) (see structure above); CAS # 134127-48-3
KF654B 2-[2-[2-Chloro-3-[(1,3-dihydro-1,3,3-trimethyl-2H-indol-2-ylidene)ethylidene]-1-cyclohexen-1-yl]ethenyl]-1,3,3-trimethyl-3H-Indolium bromide (Honeywell Specialty Chemicals, Morristown, N.J., USA); CAS # 212964-63-1
LB-6564 Phenol/cresol novolac resin (Bakelite AG, Southampton, UK.)
MAOEP N-Methacryloxyethyl)phthalimide (Monomer-Polymer & Dajac Laboratories, Feasterville, Pa., USA)
MAOES N-(Methacryloxyethyl)succinimide (Monomer-Polymer & Dajac Laboratories, Feasterville, Pa., USA)
PD140A Novolak resin, 75% m-cresol, 25% p-cresol; MW 7000 (Borden Chemical, Louisville, Ky., USA)
PD494A Novolac resin; 53% m-cresol/47% p-cresol; MW 8,000 (Borden Chemical, Louisville, Ky., USA)
PGME Propylene glycol methyl ether (1-methoxy-2-propanol)
SILIKOPHEN® P50X Phenylmethyl polysiloxane resin (Tego Chemie Service, Essen, Germany)
Substrate A 0.3 mm gauge, aluminum sheet which had been electrograined, anodized and treated with a solution of polyvinyl phosphonic acid
Substrate B 0.3 mm gauge, aluminum sheet which had been electrograined, anodized and treated with an aqueous solution of an inorganic phosphate
SWORD® Excel™ Thermally sensitive, positive working, multi-layer, printing plate precursor (Kodak Polychrome Graphics, Norwalk, Conn., USA)
XDSA 1,3-dimethyl-4,6-benzene disulfonanilide

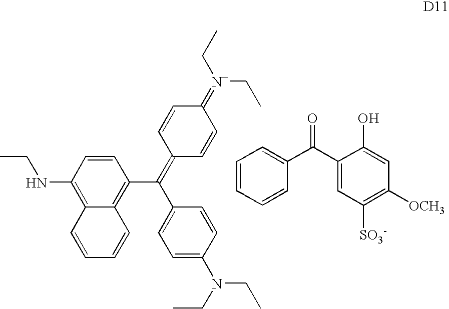

### Example 1

This example illustrates the preparation of a Copolymer 1.

A 1 l four neck round bottom flask was fitted with a heating mantle, stirrer, thermometer, condenser, and nitrogen atmosphere. A mixture of MAOEP (7.05 g) methacrylamide (4.63 g), N-phenylmaleimide (9.42 g), methacrylic acid (3.90 g), and 1,3-dioxolane/water (90:10 (v:v); 451.41 g) was added to the vessel and heated to 60° C. under a nitrogen atmosphere. Nitrogen was bubbled through the mixture for 1 h. Then the nitrogen inlet was removed from the mixture, and AIBN (0.034 g) in dioxolane (0.50 g) added to the reaction mixture. The reaction mixture was heated under nitrogen for 24 h at 60° C. The reaction mixture was cooled to room temperature, and the resulting copolymer was isolated by pouring the reaction mixture into 1 L of ethanol/water (80/20) to which five drops of concentrated hydrochloric acid had been added. The copolymer was filtered off, washed several times with 1 L of ethanol/water (80/20), filtered again, and dried to constant weight (about 2 days) at 40° C. Yield: 23.04 g (92%).

### Example 2

This example illustrates the preparation of a Copolymer 2. The procedure of Example 1 was repeated with MAOES (6.06 g), methacrylamide (4.88 g), N-phenylmaleimide (9.94 g), methacrylic acid (4.12 g), and 1,3-dioxolane/water (90:10 (v:v); 451.41 g). Yield: 24.31 g (97%).

### Example 3

This example illustrates the preparation of a Copolymer 3. The procedure of Example 1 was repeated with MAOEP (5.07 g), methacrylamide (2.78 g), N-phenylmaleimide (6.78 g), methacrylic acid (3.37 g), and 1,3-dioxolane/water (90:10 (v:v); 451.41 g). Yield: 15.07 g (84%).

### Example 4

This example illustrates the preparation of a Copolymer 4. The procedure of Example 1 was repeated with MAOEP (5.07 g), methacrylamide (2.22 g), N-phenylmaleimide (6.78 g), methacrylic acid (3.93 g), and 1,3-dioxolane/water (90:10 (v:v); 451.41 g). Yield: 15.11 g (84%).

### Examples 5-8

Imageable elements were prepared by the following procedure.

A coating solution containing 6.5 wt % of a mixture of 83 wt % of the indicated Copolymer, 15.0 wt % of IR Dye A, 0.5 wt % of BYK 307, and 1.5 wt % D11 in a mixture of 2-butanone/PGME/BLO/water (65:15:10:10 by weight) was coated onto Substrate A using a 0.03 in wire wound bar, and the resulting element dried at 135° C. for 35 sec. Coating weight of the resulting top layer: 1.5 g/m².

The following evaluation procedures were carried out.

Developer Drop Test Drops of 956 Developer were placed on the surface of the imageable layer at 2 sec intervals up to 30 sec. The time of the first visible signs of developer attack and the time to completely dissolve the imageable layer were recorded.

Resistance to Alcohol-sub Fount Drops of DAA (diacetone alcohol, 80 vol % in water) were placed on the surface of the imageable layer at 1 min intervals up to 5 min. and then washed off with water. The amount of the imageable layer removed was assessed.

Resistance to UV Wash Drops of BC (2-butoxyethanol, 80 vol % in water) were placed on the surface of the imageable layer at 1 min intervals at 22° C. up to 5 min. and then washed off with water. The amount of the imageable layer removed was assessed.

Baking Test A strip of the imageable element was placed in a Mathis Labdryer oven with a fan speed of 1000 rpm for 8 min at 230° C. Positive image remover PE3S (Kodak Polychrome Graphics, Japan Ltd) was applied to the imageable element at 2 min intervals up to 10 min. The imageable layer was immediately rinsed with water, and amount of the imageable layer removed was assessed.

The results are shown in Table 1.

TABLE 1

| | Drop Test | DAA | BC | Baking test |
|---|---|---|---|---|
| Copolymer | (sec) | (% removed) | (% removed) | (% removed) |
| 1 | 18 | 50 | 20 | 100 |
| 2 | 2 | 40 | 20 | 100 |
| 3 | 12 | 35 | 20 | 100 |
| 4 | 8 | 65 | 20 | 100 |
| C1^{a} | 6 | 40 | 30 | 100 |

^{a}Comparison example

### Examples 9-12

Multilayer imageable elements were prepared by the following procedure.

Underlayer: A coating solution containing 6.5 wt % of a mixture of 83 wt % of the indicated Copolymer, 15 wt % of IR Dye A, 0.5 wt % of BYK 307, and 1.5 wt % of D11 in a mixture of 2-butanone/PGME/BLO/water (65:15:10:10 by weight) was coated onto Substrate A using a 0.03 in wire wound bar, and the resulting element dried at 135° C. for 35 sec. Coating weight of the underlayer: 1.5 g/m².

Imageable layer: A coating solution containing 7.1 wt % of a mixture of 69.1 wt % of PD140A, 30 wt % of P3000, 0.4 wt % of ethyl violet, and 0.5 wt % of BYK 307 in diethylketone/1-methoxy-2-propanol acetate (92:8, v:v) was coated onto the underlayer using a 0.006 in wire wound bar, and the resulting imageable element dried at 135° C. for 35 sec. Coating weight of the imageable layer: 0.7 g/m².

Imaging and Processing Tests The imageable element was thermally imaged at 830 nm on a CREO® Trendsetter 3244 at 8 watts using plot 0 and plot 12 internal test patterns. The imaging energies were 130, 120, 110, 100, 90, 80, and 70 mJ/cm². The resulting imaged imageable element developed at 25° C. in a 85N Processor (Kodak Polychrome Graphics, Norwalk, Conn., USA) using 956 Developer and a processing speed of 5 feet/min. The resulting lithographic printing plates were evaluated for cleanout (lowest imaging energy at which the imaged regions are completely removed by the developer), and best resolution (imaging energy at which printing plate performs best).

The results are shown in Table 2.

TABLE 2

Minimum exposure
(mJ/cm²) required for:

| Copolymer | Clean out | Best Resolution |
|---|---|---|
| 1 | 100 | 110 |
| 2 | 90 | 100 |
| 3 | 80 | 100 |
| 4 | 80 | 80 |
| Comparison^{a} | 90 | 110 |

^{a}SWORD ® Excel ™ printing plate precursor.

### Example 13-18

Coating solutions were prepared by dissolving the components listed in Table 3 in the indicated coating solvents. The coating solutions were each coated on Substrate B using a Meyer bar. The resulting imageable elements were dried at 123° C. for 50 sec. Dry coating weight: 1.5 g/m². Then the imageable elements were heat treated at 55° C. and 25% relative humidity for 3 days.

TABLE 3

| | Example | | | | | | |
|---|---|---|---|---|---|---|---|
| | 13 | 14 | 15 | 16 | 17 | 18a | 18b |
| Imageable Layer | | | | | | | |
| LB6564 | | | | | 63.3 | 63.3 | 63.3 |
| PD494A | | | | | | 24.8 | 24.8 |
| DUREZ ® 33816 | 68 | 74 | 68 | 74 | 24.8 | | |
| Copolymer 2 | 16.3 | 10.2 | | | | | |
| Copolymer 1 | | | 16.3 | 10.2 | | | |
| CAHPh | | | | | 2.0 | 2.0 | 2.0 |
| XDSA | 5.5 | 5.6 | 5.5 | 5.6 | 5.5 | | |
| BASONYL ® | 1.9 | 1.9 | 1.9 | 1.9 | 1.9 | 2 | 2 |
| violet | | | | | | | |
| KF654b | 0.5 | 0.5 | 0.5 | 0.5 | 0.5 | 0.5 | 0.5 |
| IR Dye A | 1.4 | 1.4 | 1.4 | 1.4 | 1.4 | 1.0 | 1.0 |
| SILIKOPHEN ® | 6 | 6 | 6 | 6 | 6 | 6 | 6 |
| P50X | | | | | | | |
| Byk 307 | 0.4 | 0.4 | 0.4 | 0.4 | 0.4 | 0.4 | 0.4 |
| Coating Solvent | | | | | | | |
| Dioxolane | 65 | 65 | 65 | 65 | | 65 | |
| 2-Butanone | | | | | 20 | | 20 |
| PGME | 15 | 15 | 15 | 15 | 80 | 15 | 80 |
| BLO | 10 | 10 | 10 | 10 | | 10 | |
| Water | 10 | 10 | 10 | 10 | | 10 | |
| Byk 307 | 0.4 | 0.4 | 0.4 | 0.4 | 0.4 | 0.4 | 0.4 |

The following evaluations were carried out.

Speed Each imageable element was imaged on the CREO® Trendsetter 3244 and Mercury of the Americas Processor (Kodak Polychrome Graphics, Norwalk, Conn. USA) containing Goldstar™ Plus Developer at 22° C. at a processing speed of 750 mm/min. Speed was defined as the exposure necessary to clean out a region of 50% checkerboard pattern. Clean out was assessed by using a D196 densitometer (Gretag MacBeth, Regensdorf, Switzerland).

Developer Resistance Developer resistance, or resistance to image attack, was assessed by measuring the optical density of a solid region of the imageable layer before and after exposure to the Goldstar™ Plus Developer at the above processing conditions. The values quoted are the loss in optical density or ΔOD.

Solvent Resistance Solvent resistance was measured by measuring the ΔOD of a solid area after exposure to fountain solution. The fountain solution contained 6 wt % Astro Mark 3 fountain additive (Nikken Chemical Ltd, Tokyo, Japan), 10 wt % iso-propyl alcohol, and 84 wt % reverse osmosis purified water. ΔOD was measured between a solid area after development and a solid area that has been developed and then exposed to the fountain solution for 8 hrs.

The results are shown in Table 4.

TABLE 4

| | Copolymer (wt % in the | | | Developer | Solvent |
|---|---|---|---|---|---|
| | imageable layer) | | Speed | Resistance | resistance |
| Example | 1 | 2 | (mJ/cm²) | (ΔOD) | (ΔOD) |
| 13 | — | 16.3 | 180 | −0.48 | −0.03 |
| 14 | — | 10.2 | 180 | −0.41 | −0.05 |
| 15 | 16.3 | — | 180 | −0.45 | −0.03 |
| 16 | 10.2 | — | 180 | −0.12 | −0.01 |
| 17 | — | — | 160 | −0.17 | −0.16 |
| 18a | — | — | 170 | −0.25 | −0.23 |
| 18b | — | — | 160 | −0.45 | −0.16 |

Having described the invention, we now claim the following and their equivalents.

What is claimed is:

1. An imageable element comprising an imageable layer over a substrate, in which the imageable element comprises a photothermal conversion material and an alkali soluble copolymer comprising, in polymerized form:
(a) about 5 mol % to about 40 mol % of acrylic acid, methacrylic acid, vinyl benzoic acid, or a mixture thereof;
(b) about 20 mol % to about 75 mol % of N-phenylmaleimide, N-cyclohexylmaleimide, N-benzylmaleimide, or a mixture thereof;
(c) about 5 mol % to about 50 mol % of acrylamide, methacrylamide, N-methoxymethylacrylamide, N-methoxymethylmethacrylamide, methoxymethyl methacrylate, or a mixture thereof; and
(d) about 3 to about 50 mol % of one or more of the monomers of the formula: CH₂═CH(R¹)—C(O)—X—Y—R²;
in which:
R¹ is H or CH₃;
R² is succinimide or phthalimide;
X is O or NH;
Y is —(CH₂)ₙ—, in which n is an integer from 2 to 12; and
the copolymer is soluble in alkaline solutions.

2. The imageable element of claim 1 in which the alkali soluble copolymer comprises, in polymerized form: about 10 mol % to about 30 mol % of (a); about 20 mol % to about 50 mol % of (b); about 15 mol % to about 40 mol % of (c); and about 10 to about 40 mol % of (d).

3. The imageable element of claim 2 in which (a) is methacrylic acid; (b) is N-phenylmaleimide; (c) methacrylamide; R¹ is CH₃; X is O, and n is 2.

4. The imageable element of claim 1 in which the imageable element is a single layer imageable element, and the imageable layer comprises the copolymer, a novolac resin or mixture of novolac resins, a dissolution inhibitor or mixture of dissolution inhibitors, and the photothermal conversion material.

5. The imageable element of claim 4 in which the alkali soluble copolymer comprise, in polymerized form: about 10 mol % to about 30 mol % of (a); about 20 mol % to about 50 mol % of (b); about 15 mol % to about 40 mol % of (c); and about 10 to about 40 mol % of (d).

6. The imageable element of claim 5 in which (a) is methacrylic acid; (b) is N-phenylmaleimide; (c) methacrylamide; R¹ is CH₃; X is O, and n is 2.

7. The imageable element of claim 6 in which the imageable layer comprises about 40 wt % to about 80 wt % of the novolac resin or mixture of novolac resins, about 0.5 wt % to about 30 wt % of the dissolution inhibitor or mixture of dissolution inhibitors, 0.5 wt % to about 20 wt % of the photothermal conversion material, and about 5 wt % to about 25 wt % of the alkali soluble copolymer, based on the dry weight of the imageable layer.

8. The imageable element of claim 1 in which the element is a multilayer element comprising, in order, the imageable layer, an underlayer, and the substrate;
in which:
the imageable layer comprises (1) a novolac resin or a mixture of novolac resins and a dissolution inhibitor or mixture of dissolution inhibitors, (2) a novolac resin that comprises polar groups; or (3) a mixture thereof; and
the underlayer comprises the alkali soluble copolymer and a binder.

9. The imageable element of claim 8 in which the alkali soluble copolymer comprises, in polymerized form: about 10 mol % to about 30 mol % of (a); about 20 mol % to about 50 mol % of (b); about 15 mol % to about 40 mol % of (c); and about 10 to about 40 mol % of (d).

10. The imageable element of claim 9 in which (a) is methacrylic acid; (b) is N-phenylmaleimide; (c) methacrylamide; R¹ is CH₃; X is O, and n is 2.

11. The imageable element of claim 10 in which the photothermal conversion material is in the underlayer, and the binder comprises, in polymerized form, about 25 to about 75 mol % of N-phenylmaleimide; about 10 to about 50 mol % of methacrylamide; and about 5 to about 30 mol % of methacrylic acid.

12. A method of forming an image, the method comprising the steps of:
(i) thermally imaging an imageable element comprising a substrate and an imageable layer over the substrate, and forming an imaged imageable element comprising imaged regions and complementary unimaged regions in the imageable layer;
(ii) forming the image by developing the imaged imageable element with an alkaline developer and removing the imaged regions;
in which the imageable element comprises a photothermal conversion material and a copolymer comprising, in polymerized form:
(a) about 5 mol % to about 40 mol % of acrylic acid, methacrylic acid, vinyl benzoic acid, or a mixture thereof;
(b) about 20 mol % to about 75 mol % of N-phenylmaleimide, N-cyclohexylmaleimide, N-benzylmaleimide, or a mixture thereof;
(c) about 5 mol % to about 50 mol % of acrylamide, methacrylamide, N-methoxymethylacrylamide, N-methoxymethylmethacrylamide, methoxymethyl methacrylate, or a mixture thereof; and
(d) about 3 to about 50 mol % of one or more of the monomers of the formula: CH₂═CH(R¹)—C(O)—X—Y—R²;
in which:
R¹ is H or CH₃;
R² is succinimide or phthalimide;
X is O or NH;
Y is —(CH₂)ₙ—, in which n is an integer from 2 to 12; and
the copolymer is soluble an alkaline solution.

13. The method of claim 12 in which imaging is carried out with infrared radiation.

14. The method of claim 13 in which the alkaline developer has a pH greater than 11.

15. The method of claim 13 in which the alkali soluble copolymer comprises, in polymerized form: about 10 mol % to about 30 mol % of (a); about 20 mol % to about 50 mol % of (b); about 15 mol % to about 40 mol % of (c); and about 10 to about 40 mol % of (d).

16. The method of claim 15 in which (a) is methacrylic acid; (b) is N-phenylmaleimide; (c) methacrylamide; R¹ is CH₃; X is O, and n is 2.

17. The method of claim 13 in which the imageable element is a single layer imageable element, and the imageable layer comprises the copolymer, a novolac resin or mixture of novolac resins, a dissolution inhibitor or mixture of dissolution inhibitors, and the photothermal conversion material.

18. The method of claim 17 in which the alkali soluble copolymer comprise, in polymerized form: about 10 mol % to about 30 mol % of (a); about 20 mol % to about 50 mol % of (b); about 15 mol % to about 40 mol % of (c); and about 10 to about 40 mol % of (d).

19. The method of claim 18 in which (a) is methacrylic acid; (b) is N-phenylmaleimide; (c) methacrylamide; R¹ is CH₃; X is O, and n is 2.

20. The method of claim 19 in which the imageable layer comprises about 40 wt % to about 80 wt % of the novolac resin or mixture of novolac resins, about 0.5 wt % to about 30 wt % of the dissolution inhibitor or mixture of dissolution inhibitors, 0.5 wt % to about 20 wt % of the photothermal conversion material, and about 5 wt % to about 25 wt % of the alkali soluble copolymer, based on the dry weight of the imageable layer.

21. The method of claim 13 in which the element is a multilayer element comprising, in order, the imageable layer, an underlayer, and the substrate;
in which:
the imageable layer comprises (1) a novolac resin or a mixture of novolac resins and a dissolution inhibitor or mixture of dissolution inhibitors, (2) a novolac resin that comprises polar groups; or (3) a mixture thereof; and
the underlayer comprises the alkali soluble copolymer and a binder.

22. The method of claim 21 in which the alkali soluble copolymer comprises, in polymerized form: about 10 mol % to about 30 mol % of (a); about 20 mol % to about 50 mol % of (b); about 15 mol % to about 40 mol % of (c); and about 10 to about 40 mol % of (d).

23. The method of claim 22 in which (a) is methacrylic acid; (b) is N-phenylmaleimide; (c) methacrylamide; R¹ is CH₃; X is O, and n is 2.

24. The method of claim 23 in which the photothermal conversion material is in the underlayer, and the binder comprises, in polymerized form, about 25 to about 75 mol % of N-phenylmaleimide; about 10 to about 50 mol % of methacrylamide; and about 5 to about 30 mol % of methacrylic acid.
